(19) United States
(12) Patent Application Publication
(10) Pub. No.: US 2015/0262197 A1
(43) Pub. Date: Sep. 17, 2015

(54) TRAJECTORY BASED CONTEXT INFERENCE

(71) Applicant: QUALCOMM Incorporated, San Diego, CA (US)

(72) Inventors: Hui Chao, San Jose, CA (US); Saumitra Mohan Das, Santa Clara, CA (US)

(73) Assignee: QUALCOMM Incorporated, San Diego, CA (US)

(21) Appl. No.: 14/209,980

(22) Filed: Mar. 13, 2014

(51) Int. Cl. G06Q 30/02; H04W 4/02

(52) U.S. Cl. CPC G06Q 30/0201; H04W 4/02

(57) ABSTRACT

Method, device, and computer program product, for augmenting metadata for a mapped location is described. Mapped location trajectory data for each of a plurality of mobile devices is received. Purchase transaction data for the respective mobile device at the mapped location is received from each of the respective mobile devices. The purchase transaction data is correlated with the mapped location trajectory data to determine a purchased product location within the mapped location. The metadata for the mapped location is augmented to include the purchased product location.

### FIELD

The subject matter disclosed herein relates generally to map context determination.

### BACKGROUND

Electronic devices may include a variety of sensors and inputs to monitor and infer relative device position. For example, based on input received by a WiFi sensor, a device can measure Received Signal Strength Indication (RSSI) or Round Trip Time (RTT) to infer device position relative to one or more wireless beacons (e.g., WiFi access points). Indoor positioning systems can send and receive maps containing the physical layout of a building or floor as well as information about the location of wireless beacons. For example, a map may include wall and window information for a venue, as well as RSSI and RTT heatmaps for wireless beacons. When a mobile device begins communication with a location server at location, the mobile device can retrieve some or all of the map information used to determine position of the mobile device. However, maps traditionally used for navigation and Location Based Services (LBS) lack context information useful for features beyond mobile device positioning and indoor navigation.

### SUMMARY OF THE DESCRIPTION

Embodiments disclosed herein may relate to a method for augmenting metadata for a mapped location. The method includes receiving mapped location trajectory data for each of a plurality of mobile devices. The method also includes receiving, for each of the respective mobile devices, purchase transaction data for the respective mobile device at the mapped location. The method also includes correlating the purchase transaction data with the mapped location trajectory data to determine a purchased product location within the mapped location. The method further includes augmenting the metadata for the mapped location to comprise product locations.

Embodiments disclosed herein may also relate to a machine readable non-transitory storage medium with instructions to augment metadata for a mapped location. The medium includes instructions to receive mapped location trajectory data for each of a plurality of mobile devices. The medium also includes instructions to receive, for each of the respective mobile devices, purchase transaction data for the respective mobile device at the mapped location. The medium also includes instructions to correlate the purchase transaction data with the mapped location trajectory data to determine a purchased product location within the mapped location. The medium further includes instructions to augment the metadata for the mapped location to comprise the purchased product location.

Embodiments disclosed herein may further relate to a data processing device including a processor and a storage device configurable to store instructions to augment metadata for a mapped location. The device includes instructions to receive mapped location trajectory data for each of a plurality of mobile devices. The device also includes instructions to receive, for each of the respective mobile devices, purchase transaction data for the respective mobile device at the mapped location. The device also includes instructions to correlate the purchase transaction data with the mapped location trajectory data to determine a purchased product location within the mapped location. The device further includes instructions to augment the metadata for the mapped location to comprise the purchased product location.

Other features and advantages will be apparent from the accompanying drawings and from the detailed description.

### BRIEF DESCRIPTION OF THE DRAWINGS

FIG. 1 is block diagram illustrating an exemplary operating environment of Contextual Map Augmentation;

FIG. 2 is block diagram illustrating an exemplary device in which embodiments of Contextual Map Augmentation may be practiced;

FIG. 3 is block diagram illustrating an exemplary server in which embodiments of Contextual Map Augmentation may be practiced;

FIG. 4 is a flow diagram illustrating an exemplary method of Contextual Map Augmentation;

FIG. 5 is a flow diagram illustrating another exemplary method of Contextual Map Augmentation;

FIG. 6 illustrates an exemplary device trajectory of a first device within a mapped location;

FIG. 7 illustrates an exemplary device trajectory of a second device within a mapped location;

FIG. 8 illustrates an exemplary device trajectory of a third device within a mapped location;

FIG. 9 illustrates an exemplary purchased product location within a mapped location; and

FIG. 10 illustrates exemplary product category locations within a mapped location.

### DESCRIPTION

Aspects of the invention are disclosed in the following description and related drawings directed to specific embodiments of the invention. Alternate embodiments may be devised without departing from the scope of the invention. Additionally, well-known elements of the invention may not be described in detail or may be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device (e.g., a server or device). It will be recognized that various actions described herein can be performed by specific circuits (e.g., application specific integrated circuits), by program instructions being executed by one or more processors (e.g., executable program instructions), or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

In one embodiment, a Contextual Map Augmentation (CMA) module or engine tracks mobile device trajectory and purchase receipts for multiple mobile devices in a location. CMA can correlate device trajectories from multiple separate mobile devices (e.g., through crowdsourcing of user's devices at the location) associated with a particular product purchase in order to locate products within the location. In response to correlating the trajectories and purchases, CMA can determine a variety of metadata or context information that can be associated with a location (e.g., mapped location). For example, in addition to determining product location, CMA can determine how long users spend at a product display, locations of product categories/sections, purchase ratios, profit ratios, and other metadata or context information.

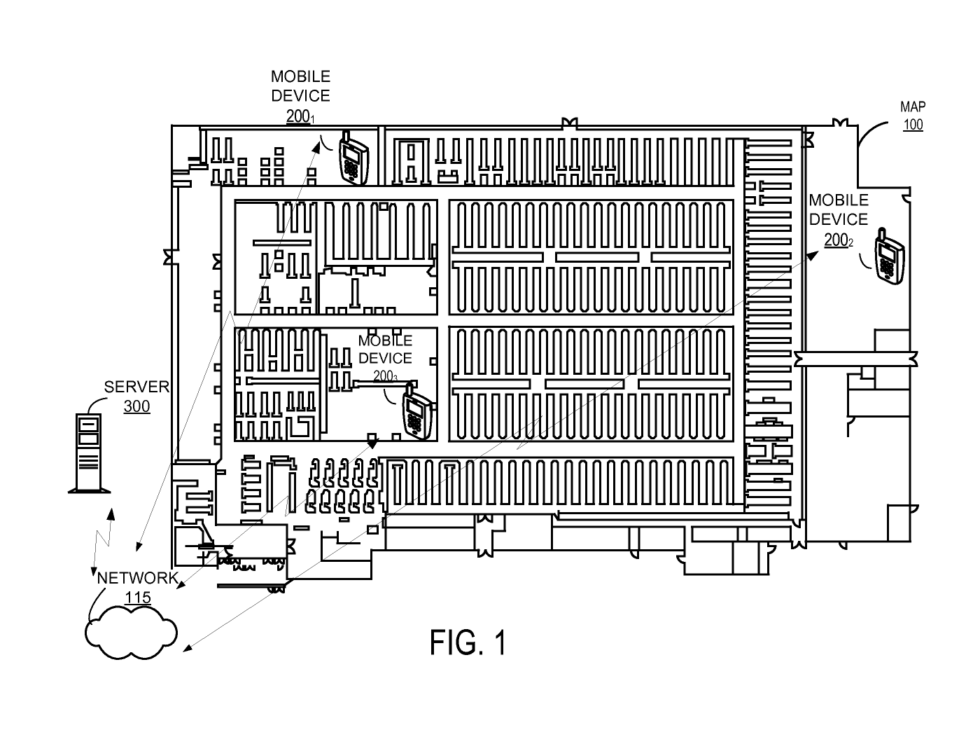

FIG. 1 is block diagram illustrating an exemplary system in which embodiments of the invention may be practiced. In one embodiment, devices (e.g., mobile devices 200_{1-N}) record trajectory and purchase transaction data for activities performed in the mapped location 100. Devices can send the recorded data through a network (e.g., network 115) to a CMA server (e.g., CMA server 300). The network 115 may operate in buildings and perform communications over WiFi, LAN, Cellular, or Wide Area Network. CMA implemented at a server and device(s) may maintain one or more versions of a CMA map (e.g., map 100) of a location. The location may be a venue, building, or structure, referred to herein as the “mapped location.” The CMA map may include or reference metadata/context information associated with or inferred from mobile device trajectory information as described in greater detail below. Each device may have positioning capability (e.g., Wi-Fi positioning, GPS, etc.) to determine the position of the mobile device at specified time intervals and enable map metadata augmentation as described herein.

In one embodiment, a location (e.g., the location illustrated by map 100) may initially be partially or entirely unmapped. Trajectory and metadata information may be added, augmented, or integrated into a map of the location in response to correlating multiple mobile device trajectories for a same product. Trajectory information for multiple mobile devices may be correlated according to a common coordinate system (e.g., based upon an initial known coordinate of each trajectory) independent of the presence of map details. CMA can detect multiple trajectories having a same purchase item overlap in a particular trajectory section (e.g., polygon, or set/plurality of location coordinates) and CMA can determine the location of the purchased product within the trajectory with or without a map to describe surrounding context of the trajectory. If map details are missing or incomplete, context inferences or metadata may be associated particular each respective trajectory section (e.g., polygon or set of coordinates). In one embodiment, metadata associated with mobile device trajectories may be integrated (e.g., linked, assigned, or augmented) with a map of the location by CMA or alternatively, by one or more other separate independent components, engines, or modules.

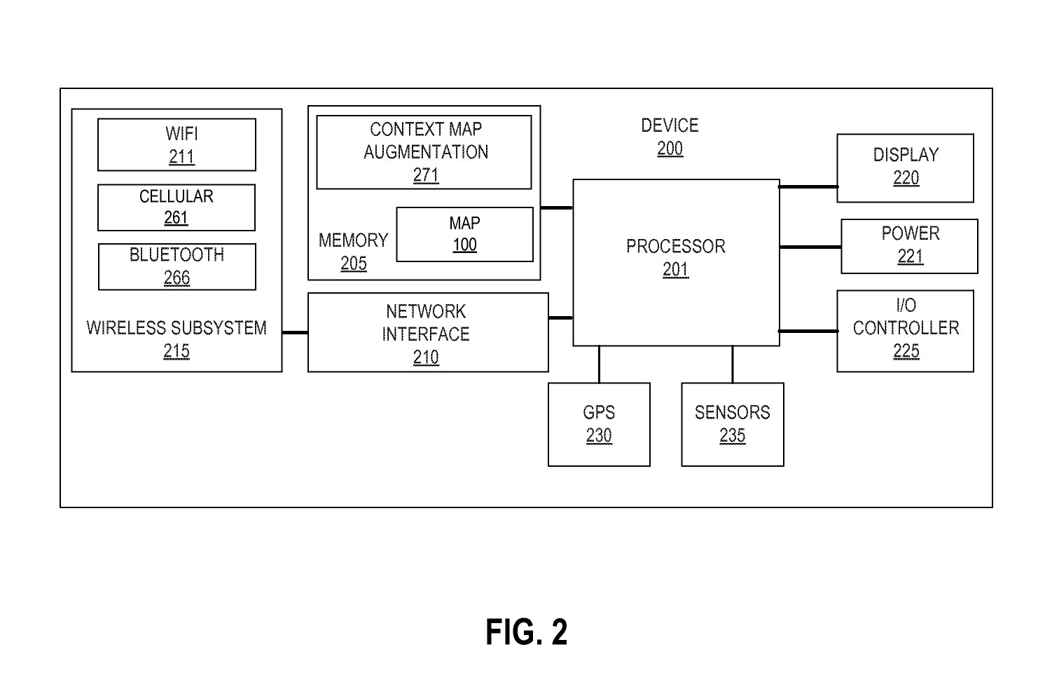

FIG. 2 is block diagram illustrating an exemplary device in which embodiments of the invention may be practiced. The device (e.g., device 200) may include one or more processors (e.g., a general purpose processor, specialized processor, or digital signal processor), a memory 205, I/O controller 225, and network interface 210. The device 200 may also include a number of device sensors coupled to one or more buses or signal lines further coupled to the processor(s) 201. It should be appreciated that device 200 may also include a display 220, a user interface (e.g., keyboard, touch-screen, or similar devices), a power device 221 (e.g., a battery), as well as other components typically associated with electronic devices. In some embodiments, the device 200 may be a mobile or non-mobile device.

The device (e.g., device 200) can include sensors 235 such as a clock, ambient light sensor (ALS), accelerometer, gyroscope, magnetometer, temperature sensor, barometric pressure sensor, red-green-blue (RGB) color sensor, ultra-violet (UV) sensor, UV-A sensor, UV-B sensor, compass, proximity sensor, and/or near field communication (NFC). The device may also include a Global Positioning Sensor (GPS) 230. In some embodiments, multiple cameras are integrated or accessible to the device. In some embodiments, other sensors may also have multiple versions or types within a single device.

Memory 205 may be coupled to processor 201 to store instructions (e.g., instructions to perform CMA 271) for execution by processor 201. In some embodiments, memory 205 is non-transitory. Memory 205 may also store one or more models or modules to implement embodiments described below. Thus, the memory 205 is a processor-readable memory and/or a computer-readable memory that stores software code (programming code, instructions, etc.) configured to cause the processor 201 to perform the functions described. Alternatively, one or more functions of CMA may be performed in whole or in part in device hardware.

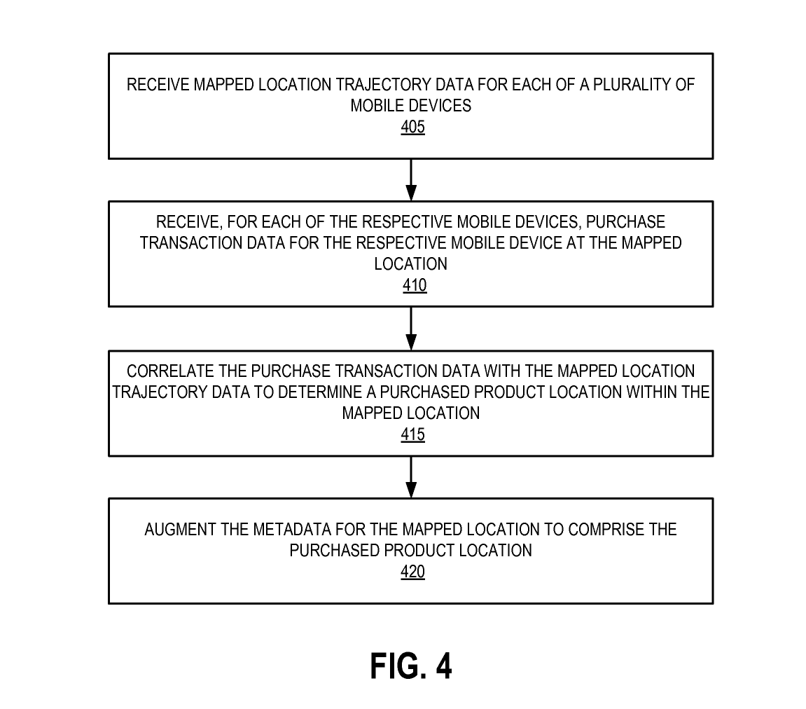

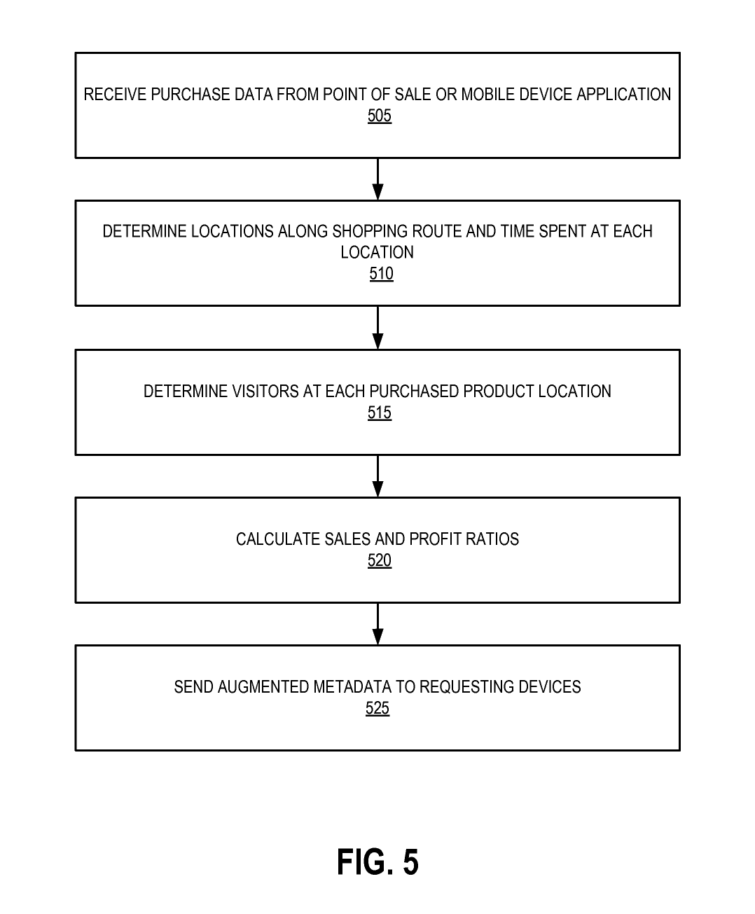

Memory 205 may also store data from integrated or external sensors. In addition, memory 205 may store application program interfaces (APIs) for accessing CMA. In some embodiments, CMA functionality (e.g., as described below with regards to FIGS. 5 and 4) can be implemented in memory 205. In other embodiments, CMA functionality can be implemented as a module separate from other elements in the device 200. The CMA module may be wholly or partially implemented by other elements illustrated in FIG. 2, for example in the processor 201 and/or memory 205, or in one or more other elements of the device 200.

Network interface 210 may also be coupled to a number of wireless subsystems 215 (e.g., Bluetooth 266, Wi-Fi 211, Cellular 261, or other networks) to transmit and receive data streams through a wireless link to/from a wireless network, or may be a wired interface for direct connection to networks (e.g., the Internet, Ethernet, or other wireless systems). The mobile device may include one or more local area network transceivers connected to one or more antennas. The local area network transceiver comprises suitable devices, hardware, and/or software for communicating with and/or detecting signals to/from WAPs, and/or directly with other wireless devices within a network. In one aspect, the local area network transceiver may comprise a Wi-Fi (802.11x) communication system suitable for communicating with one or more wireless access points.

The device 200 may also include one or more wide area network transceiver(s) that may be connected to one or more antennas. The wide area network transceiver comprises suitable devices, hardware, and/or software for communicating with and/or detecting signals to/from other wireless devices within a network. In one aspect, the wide area network transceiver may comprise a CDMA communication system suitable for communicating with a CDMA network of wireless base stations; however in other aspects, the wireless communication system may comprise another type of cellular telephony network or femtocells, such as, for example, TDMA, LTE, Advanced LTE, WCDMA, UMTS, 2G, 3G, 4G, or GSM. Additionally, any other type of wireless networking technologies may be used, for example, WiMax (802.16), Ultra Wide Band, ZigBee, wireless USB, etc. In conventional digital cellular networks, position location capability can be provided by various time and/or phase measurement techniques. For example, in CDMA networks, one position determination approach used is Advanced Forward Link Trilateration (AFLT). Using AFLT, a server may compute its position from phase measurements of pilot signals transmitted from a plurality of base stations.

The device as used herein (e.g., device 200) may be a: mobile device, wireless device, cell phone, personal digital assistant, mobile computer, wearable device (e.g., watch, head mounted display, virtual reality glasses, etc.), tablet, personal computer, laptop computer, or any type of device that has processing capabilities. As used herein, a mobile device may be any portable, or movable device or machine that is configurable to acquire wireless signals transmitted from, and transmit wireless signals to, one or more wireless communication devices or networks. Thus, by way of example but not limitation, the device 200 may include a radio device, a cellular telephone device, a computing device, a personal communication system device, or other like movable wireless communication equipped device, appliance, or machine. The term “mobile device” is also intended to include devices which communicate with a personal navigation device, such as by short-range wireless, infrared, wire line connection, or other connection—regardless of whether satellite signal reception, assistance data reception, and/or position-related processing occurs at the device 200. Also, “mobile device” is intended to include all devices, including wireless communication devices, computers, laptops, etc. which are capable of communication with a server, such as via the Internet, Wi-Fi, or other network, and regardless of whether satellite signal reception, assistance data reception, and/or position-related processing occurs at the device, at a server, or at another device associated with the network. Any operable combination of the above can also be considered a “mobile device” as used herein. Other uses may also be possible. While various examples given in the description below relate to mobile devices, the techniques described herein can be applied to any device for which accurate context inference is desirable.

The device may communicate wirelessly with a plurality of WAPs using RF signals (e.g., 2.4 GHz, 3.6 GHz, and 2.9/5.0 GHz bands) and standardized protocols for the modulation of the RF signals and the exchanging of information packets. For example, the protocol may be Institute of Electrical and Electronics Engineers (I3) 802.11x. By extracting different types of information from the exchanged signals, and utilizing the layout of the network (i.e., the network geometry) the mobile device may determine position within a predefined reference coordinate system.

It should be appreciated that embodiments of the invention as will be hereinafter described may be implemented through the execution of instructions, for example as stored in the memory 205 or other element, by processor 201 of device and/or other circuitry of device and/or other devices. Particularly, circuitry of device, including but not limited to processor 201, may operate under the control of a program, routine, or the execution of instructions to execute methods or processes in accordance with embodiments of the invention. For example, such a program may be implemented in firmware or software (e.g. stored in memory 205 and/or other locations) and may be implemented by processors, such as processor 201, and/or other circuitry of device. Further, it should be appreciated that the terms processor, microprocessor, circuitry, controller, etc., may refer to any type of logic or circuitry capable of executing logic, commands, instructions, software, firmware, functionality and the like.

Some or all of the functions, engines or modules described herein (e.g., CMA) may be performed by the device itself and/or some or all of the functions, engines or modules described herein may be performed by another system connected through I/O controller 225 or network interface 210 (wirelessly or wired) to the device. Thus, some and/or all of the functions may be performed by another system and the results or intermediate calculations may be transferred back to the device. In some embodiments, such other device may comprise a server configured to process information in real time or near real time. In some embodiments, the other device is configured to predetermine the results, for example based on a known configuration of the device. Further, one or more of the elements illustrated in FIG. 2 may be omitted from the device. For example, one or more of the sensors 235 may be omitted in some embodiments.

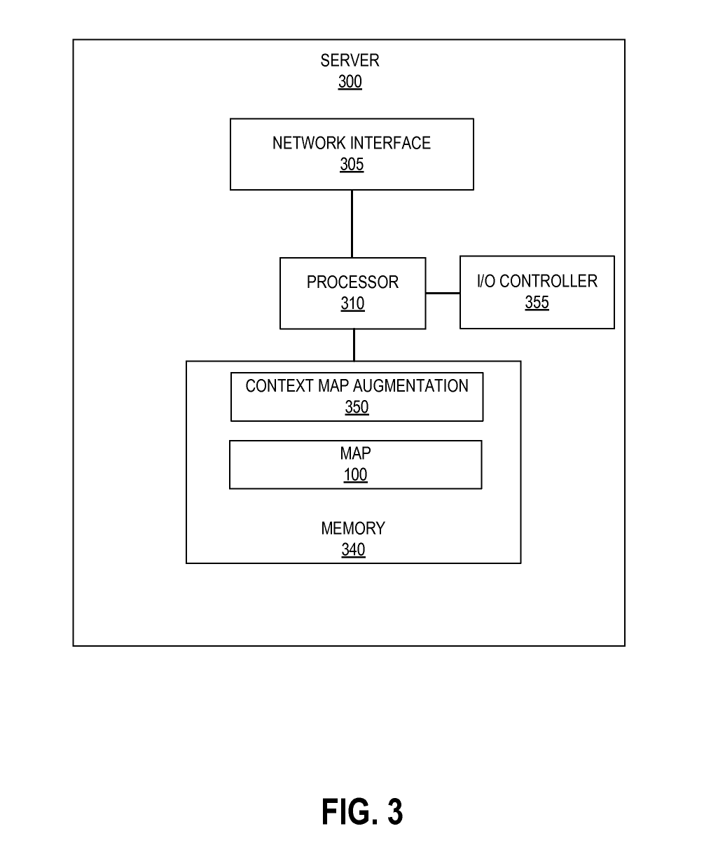

FIG. 3 is block diagram illustrating an exemplary server in which embodiments of the invention may be practiced. For the sake of simplicity, the various features and functions illustrated in the box diagram of FIG. 3 are connected together using a common bus meant to represent that these various features and functions are operatively coupled together. Those skilled in the art will recognize that other connections, mechanisms, features, functions, or the like, may be provided and adapted as necessary to operatively couple and configure a data processing system (e.g., server 300). Further, it is also recognized that one or more of the features or functions illustrated may be further subdivided or combined.

In some embodiments, the server 300 may be a position server, application server, map server, location server, or have other duties in addition to performing CMA. In other embodiments, the server 300 may be dedicated to performing CMA. The server 300 may include a network interface 305 configured to communicate with a network (not shown), which may be configured to communicate with other servers, computers, and devices (e.g., device 200).

A processor 310 may be connected to the network interface 305, and the memory 340. The processor may include one or more microprocessors, microcontrollers, and/or digital signal processors that provide processing functions, as well as other calculation and control functionality. The memory 340 can store data and software instructions for executing programmed functionality within the server. The memory 340 may be on-board the processor 310 (e.g., within the same IC package), and/or the memory may be external memory to the processor and functionally coupled over a data bus. The details of software functionality associated with aspects of the disclosure will be discussed in more detail below.

A number of software modules or data tables may reside in memory 340 and be utilized by the processor 310 in order to manage communications, and CMA functionality. As illustrated in FIG. 3, the server memory 340 may include instructions to perform CMA 350. The server memory may also store the map 100. Memory contents as shown in FIG. 3 is merely exemplary, and as such the functionality of the modules and/or data structures may be combined, separated, and/or be structured in different ways depending upon the implementation of the mobile device. In one embodiment, CMA 350 may be a process running on the processor 310 of the server 300 which implements CMA.

The server may optionally store trajectory or motion data in memory that may be derived from data derived from one or more sensors of the device 200. Moreover, supplemental information may include, but not be limited to, information that can be derived or based upon Bluetooth signals, beacons, RFID tags, and/or information derived from a map (e.g., receiving coordinates from a digital representation of a geographical map by, for example, a user interacting with a digital map).

Processor 310 may include any form of logic suitable for performing at least the techniques provided herein. For example, processor 310 may be operatively configurable based on instructions in memory 340 to selectively initiate one or more routines that initialize trajectory or motion data capture at the mobile device.

The server may include an input/output controller 355 to provide any suitable interface systems, such as a microphone/speaker, keypad, and display that allows for local input to the server.

CMA as described herein may be implemented as software, firmware, hardware, module, or engine. In one embodiment, CMA as described herein may be implemented by one or more general purpose processors (e.g., device processor 201 and/or server processor 310) and in memory (e.g., device memory 205 or server memory 340) to achieve the desired functions (e.g., the methods of FIG. 4 and FIG. 5).

In some embodiments, the CMA server may initiate a request for trajectory and purchase transaction data from one or more mobile devices. For example, a administrator or manager (e.g., associated with the mapped location) may determine one or more aspects of a map (e.g., map 100) are out of date or should be refreshed. The administrator or manager may trigger a request (e.g., to CMA) for additional or updated trajectory and purchase transaction data. In another example, map data may become stale or out of date automatically after a defined amount of time has expired, or in response to other predetermined criteria.

In some embodiments, the CMA server may predict likelihood that a particular mobile device (user) may provide new or updated metadata or context information. For example, the CMA server interface with (e.g., connect to or receive updates from) mobile device shopping applications while the mobile device is at or near the mapped location. In one embodiment, the mobile device shopping applications may manage shopping lists or wish lists associated with the mapped location. CMA can determine the user associated with the mobile device intends to purchase a particular item at the mapped location based on data from the mobile device applications (e.g., shopping/wish lists). In one embodiment, in response to determining a mobile device at the mapped location and has an item on a shopping list in an unmapped or low metadata section of the map, the CMA server may issue a request for trajectory and purchase information from the particular mobile device.

In other embodiments, CMA may estimate from past purchases whether a mobile device is likely to purchase similar products in a current visit. Therefore, CMA may estimate that a particular mobile device may be able to provide specific product inference information for a mapped location. For example, a user may have historically purchased soft drinks most times they visit a store. CMA may request the user allow trajectory tracking on their current visit in order to provide updated context information regarding the location of soft drinks, or request data to track the effectiveness of the product display at the store (e.g., the mapped location).

FIG. 4 is a flow diagram illustrating an exemplary method of Contextual Map Augmentation. At block 405, the embodiment (e.g., CMA) receives mapped location trajectory data for each of a plurality of mobile devices. For example, in response to completing a purchase of an item within a mapped location, the CMA server may receive an entire trajectory record from a mobile device's visit at the mapped location along with the purchase transaction data. In other embodiments, a mobile device may provide (e.g., to the CMA server) live or streaming updates of their position within a mapped location and the CMA server may further process the coordinate or position information.

At block 410, the embodiment receives, for each of the respective mobile devices, purchase transaction data for the respective mobile device at the mapped location. CMA can receive purchase transaction data from multiple mobile devices within a mapped location.

At block 415, the embodiment correlates the purchase transaction data with the mapped location trajectory data to determine a purchased product location within the mapped location. CMA can match trajectories resulting in the same product purchase with each other in order to determine overlapping visited areas. For example, given a first mobile device trajectory resulting in a purchased product, and a second mobile device trajectory also providing the same purchased product, the correlated or overlapping section of the two trajectories indicates the purchased product's location.

At block 420, the embodiment augments the metadata for the mapped location to comprise the purchased product location. In some embodiments, the CMA map includes metadata descriptions (e.g., context) inferred from trajectories from users (e.g., mobile devices) and the user's associated product purchases. The metadata or context may be integrated, linked or associated with one or more coordinates or sections of a map. For example, one or more of: product category types, sales information, product locations, or customer viewing time may be associated with sections or points in the CMA map.

FIG. 5 is a flow diagram illustrating another exemplary method of Contextual Map Augmentation. At block 505, the embodiment (e.g., CMA) receives purchase data from a point of sale or mobile device application. For example, device 200 may include a mobile payment system or digital wallet to record and send purchase transaction data associated with the mapped location. The device 200 may have a user editable configuration file to specify what type and frequency of transaction data allowed for upload to the CMA server 300. In some embodiments, the device 200 may include a mobile application such as a store loyalty program or store sponsored application that can provide purchase transaction data to the CMA server 300. The device 200 may be configured to track coupon redemption and shopping lists in addition to incorporating a payment system. In some embodiments, purchase transaction data may be inferred from shopping lists or wish lists if actual purchase receipts are unable to be verified. In some embodiments, a point of sale maintained by a store or venue (e.g., the mapped location) provides the server with purchase transaction data associated with a user. For example, the network enabled cash register may provide notification to the CMA server that a user has purchased one or more products. The CMA server can associate mobile device purchases with the trajectory data received from the same mobile device.

At block 510, the embodiment determines locations along a shopping route and time spent at each location. For example, the mobile device may send trajectory information (e.g., map coordinates, or pedestrian dead reckoning information from mobile device sensors) with associated time stamps to the CMA server. In some embodiments, CMA triggers recording of mobile device trajectory in response to determining a user or mobile device arrives at a mapped location. For example, in response to the user's mobile device detecting a wireless beacon (e.g., Bluetooth or WiFi) broadcast at the mapped location, CMA may trigger trajectory tracking at the mobile device.

At block 515, the embodiment determines a number of visitors at each purchased product location. For example, for each purchased product, CMA attempts to determine location coordinates of the product within the mapped location by correlating the trajectory of all mobile devices purchasing the same product. If a precise coordinates/location of the product may not be determined, CMA creates a polygon (or other geometric) representation of the area containing correlated points from multiple mobile devices purchasing a particular product or category. For example, multiple users may visit the same section of the store and may travel through to purchase a specific product, and CMA may use a polygon representation of the section of the store to represent the product location until a mobile device having a more narrow or targeted trajectory provides CMA with data to infer a more precise location of the product. In one embodiment, each time a mobile device has a trajectory within a threshold range of a purchased product location, a visitor count or tally is incremented for the product location. Therefore, CMA can track visitors to a product display and provide statistics about how long a user lingers within a display and whether users are purchasing items from the display, just to name a few possible uses. In some embodiments, a coordinate threshold is configured such that users may approximately match (correlate) to a particular location coordinate or set of location coordinates. For example, while in front of a toothpaste shelf some users may be within a foot or two of the toothpaste and CMA can consider their location to be at the product location. Persons of skill in the art will recognize that the mobile device location tracking (e.g., determining of a user's coordinates within the map may be implemented with any state of the art tracking techniques available.

At block 520, the embodiment calculates sales and profit ratios. In some embodiments, for each product location (e.g., one or more coordinates or a polygon area) CMA determines a sales to visitor ratio “R” for items/products at the mapped location. Sales may be defined as a recorded purchase by a user, and visitors may be defined as a user trajectory For example, the ratio “R” may be calculated as sales per total number of visitor ratio:

$$R = \frac{Number of Purchases at the Product Location}{Number of Visitors to the Product Location} \qquad Eq . 1$$

In one embodiment, “R” measures product display effectiveness in sales for each product or product category. In some embodiments, CMA may issue alerts, notifications, or reports when CMA detects that “R” reaches predetermined thresholds. In other embodiments, “R” is reported out in a manually triggered or automatically reported document. For example, “R” may be reported out to store managers who can re-design a store layout according to effectiveness of a current layout and amount or type of inventory to sell. “R” value can be interpreted by users as indicating areas shoppers visit without purchasing product, and areas where shoppers visit and purchase product. “R” is especially valuable in a dynamic environment, where interior arrangement or crowd density changes with time, and CMA reporting can provide location management with up to date sales and product information for specific locations and displays. Other ratios may be stored and recorded into CMA map metadata, such as a ratio “R′” that may be calculated by:

$${R}^{′} = \frac{Revenue or Profit}{Number of Visitors to the Product Location} \qquad Eq . 2$$

At block 525, the embodiment sends augmented metadata to requesting devices. Mobile devices may request maps and/or metadata from the CMA server. For example, a mobile device may issue a request for metadata relating to a particular product location in order to quickly find the product or categories/sections within the mapped location. The mobile device may also request metadata to support shopping or map related mobile device applications. For example, a mobile application leveraging the map metadata may request product location in order to provide indoor navigation to products in a user's shopping list. In one embodiment, CMA executed at a CMA server may process incoming trajectories and purchase transaction data from multiple mobile devices in order to update a CMA map. The CMA map may be maintained at the CMA server and a representation of the CMA map can be distributed to requesting mobile devices. For example, some or all of the metadata or context information may be sent to a requesting mobile device with or without one or more parts of the CMA map (e.g., the mobile device may already have a map of the location).

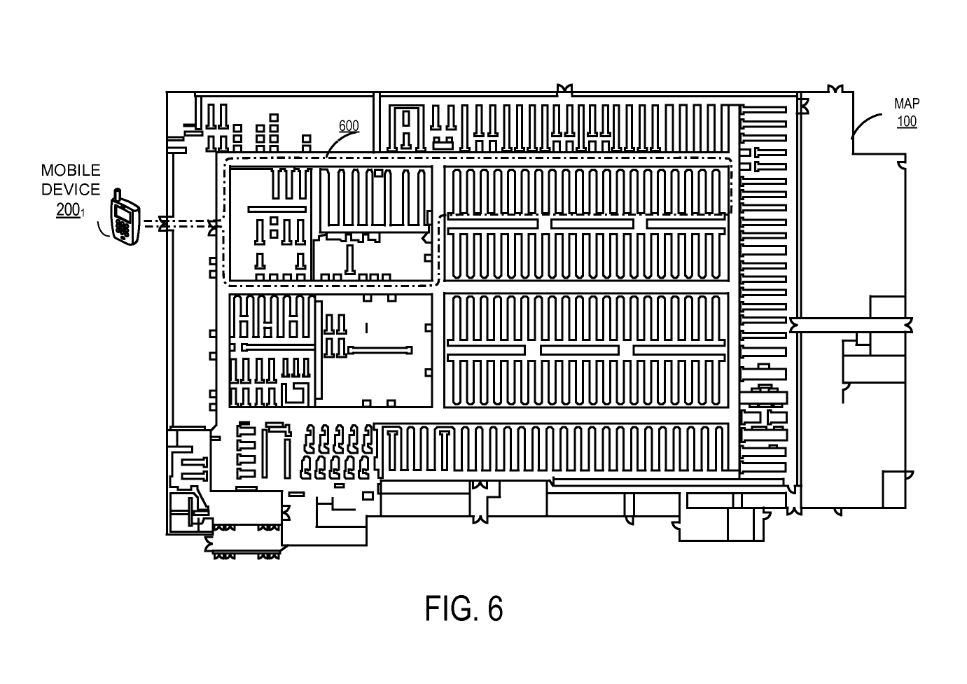

FIG. 6 illustrates an exemplary device trajectory of a first device within a mapped location. With reference to FIG. 6, a mobile device (e.g., device 200₁) has a trajectory (e.g., a recorded shopping trajectory 600) within the mapped location (e.g., illustrated in map 100). For example, the mobile device 200₁ may have purchased toothpaste, milk, and candy.

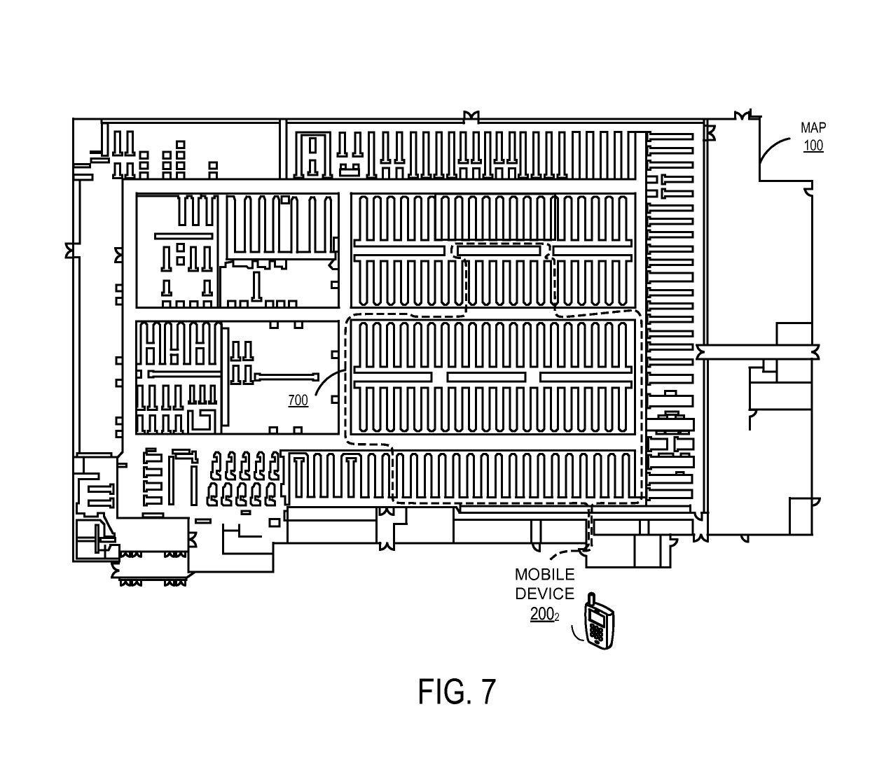

FIG. 7 illustrates an exemplary device trajectory of a second device within a mapped location. With reference to FIG. 7, a mobile device (e.g., device 200₂) has a trajectory (e.g., a recorded shopping trajectory 700) within the mapped location. For example, the mobile device 200₂ may have purchased cookies, and toothpaste.

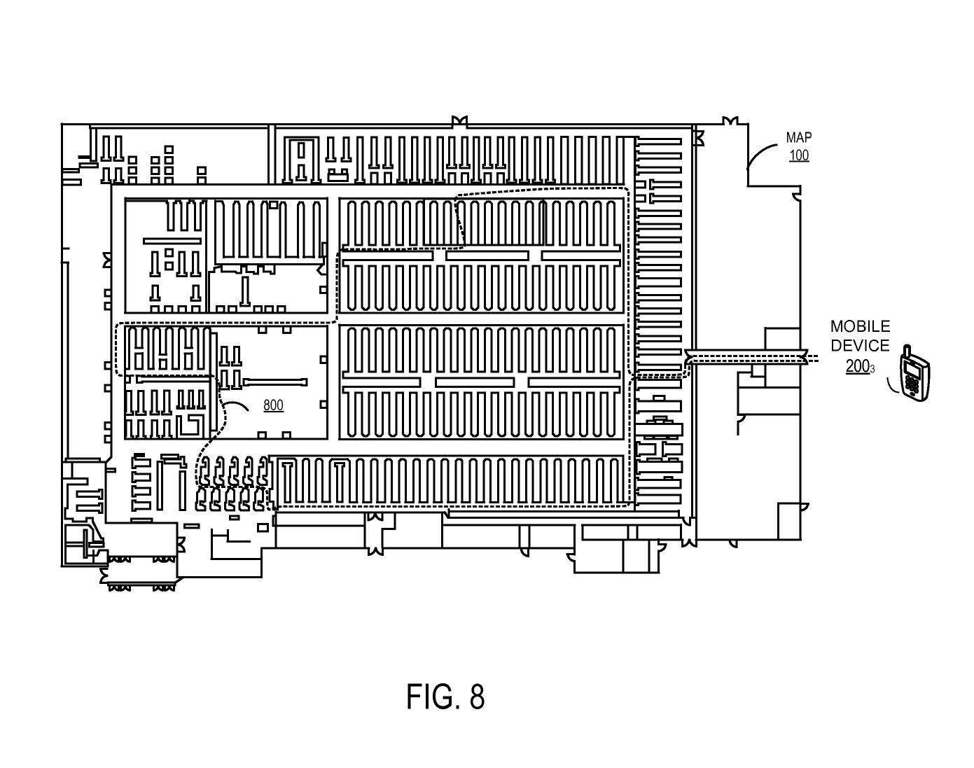

FIG. 8 illustrates an exemplary device trajectory of a third device within a mapped location. With reference to FIG. 8, a mobile device (e.g., device 200₃) has a trajectory (e.g., a recorded shopping trajectory 800) within the mapped location. For example, the mobile device 200₃ may have purchased toothpaste, and milk.

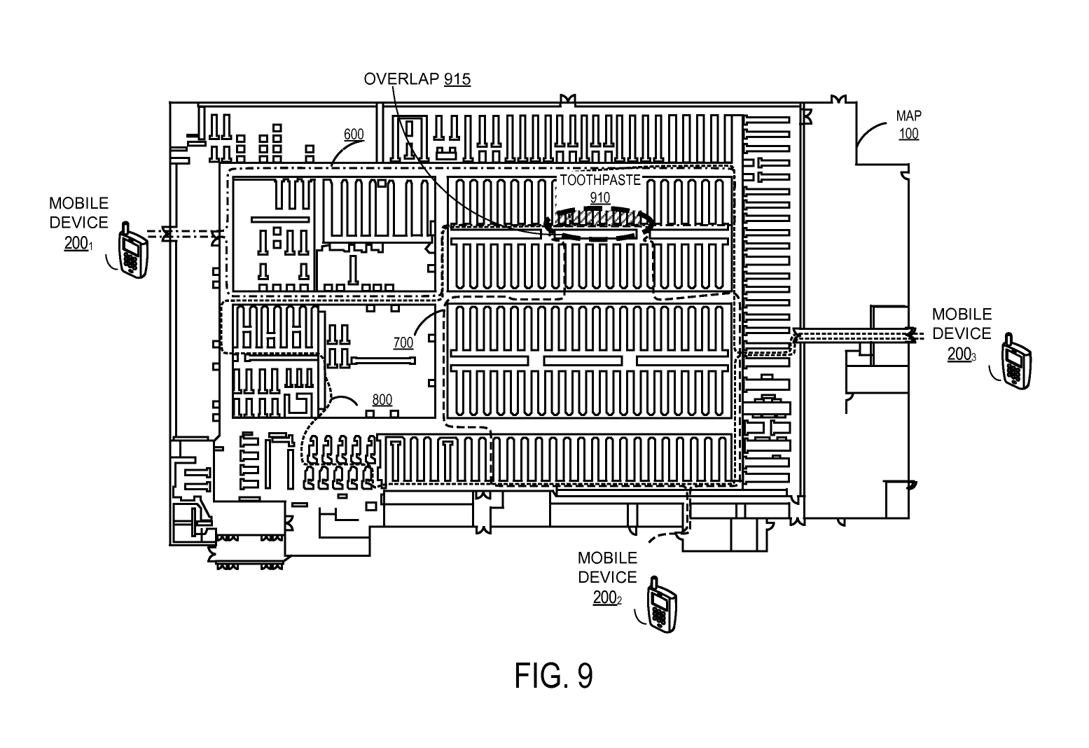

FIG. 9 illustrates an exemplary purchased product location within a mapped location. With reference to FIG. 9, overlap 915 is the area where two or more mobile device (e.g., 200₁, 200₂, and 200₃) trajectories align. In some embodiments, overlap 915 may be a single common point (e.g., x,y coordinates in the mapped location that two or more devices share), or may be a set of multiple points (e.g., a polygon or other geometric representation of a cluster of overlapping/correlated coordinates). As more mobile device trajectories are learned (e.g., received at the CMA server and correlated with other trajectories having a common purchase) common overlap points or sections may be refined. For example, with just two mobile device trajectories resulting in a same purchased item the overlap area may be relatively large, however, as more mobile device trajectories resulting in a common purchase are discovered the overlap area may become smaller or more narrow in scope. As the overlap area shrinks, the accuracy of the purchased product location may be increased. For example, a large overlap area may include purchased product locations for additional products beyond the particular purchased product, whereas a smaller overlap area may be specific enough to contain only the particular purchased product.

With reference to FIG. 9, mobile devices 200₁, 200₂, and 200₃ are all associated with a same item purchase, the toothpaste 910. Having three trajectories with a common purchase enables CMA to determine the purchased item was obtained from the common overlap area (overlap 915) that all three mobile devices, and associated user shoppers visited. Therefore, the resulting overlap area correlated with the three trajectories and the toothpaste purchase can be associated with the toothpaste product (e.g., purchased product location for toothpaste). In some embodiments, the overlap area (e.g., purchased product location) for the purchased product(s) may be further associated with a product category (e.g., toothpaste may be associated with personal care/hygiene).

In other embodiments, each purchased product may have a predetermined product category or category type. Instead of, or in addition to, determining correlation of trajectories to individual products, correlation can be determined for product categories. For example, toothbrushes and toothpaste may both be assigned to the personal care category. Categories may be pre-assigned by an editable configuration file having each available product sold in the mapped location and a respective category type. For example bicycles may be assigned to the sporting goods category, milk as dairy, cookies as snacks, televisions as electronics, stuffed animals are toys, etc.). In response to determining a plurality of mobile devices has purchased from a product category (e.g., personal care) and have a common trajectory (e.g., passed through overlap 915), CMA can assign the correlated trajectory (respective overlap 915) to the broad product category (e.g., personal care).

In some embodiments, CMA augments metadata of the map to associate the overlap area with the purchased product to result in a purchase product location. For example, the overlap area within a map may be flagged or associated with a purchased product or category. In one embodiment, CMA compares each mobile device trajectory having a same product purchase and augments metadata associated with all common or correlated points from the trajectories. The augmented metadata can include an association with the particular purchased product. For example, metadata for points (1,4) and (1,3) on an x,y coordinate plane (e.g., map) may be associated with the product “milk.”

In some embodiments, CMA waits until an overlap area reaches a threshold size before assigning metadata. For example, if relatively few mobile devices provide trajectory and purchase data, the overlap area may not be precise enough to be beneficial and CMA may wait until the size of the overlap area shrinks to a threshold before updating the map. In one embodiment, the overlap area is written to map metadata when the area is a single contiguous area or polygon. For example, if the purchased product and trajectory correlation results in two or more separate overlap areas, CMA may wait until enough correlated trajectory and purchase data is obtained to isolate the overlap area to less than two distinct and separate locations. In other embodiments, user configuration may allow for multiple separate overlap areas for a product. For example, items such as candy and batteries may be sold in multiple different locations such as a dedicated section within a store as well as near a checkout counter.

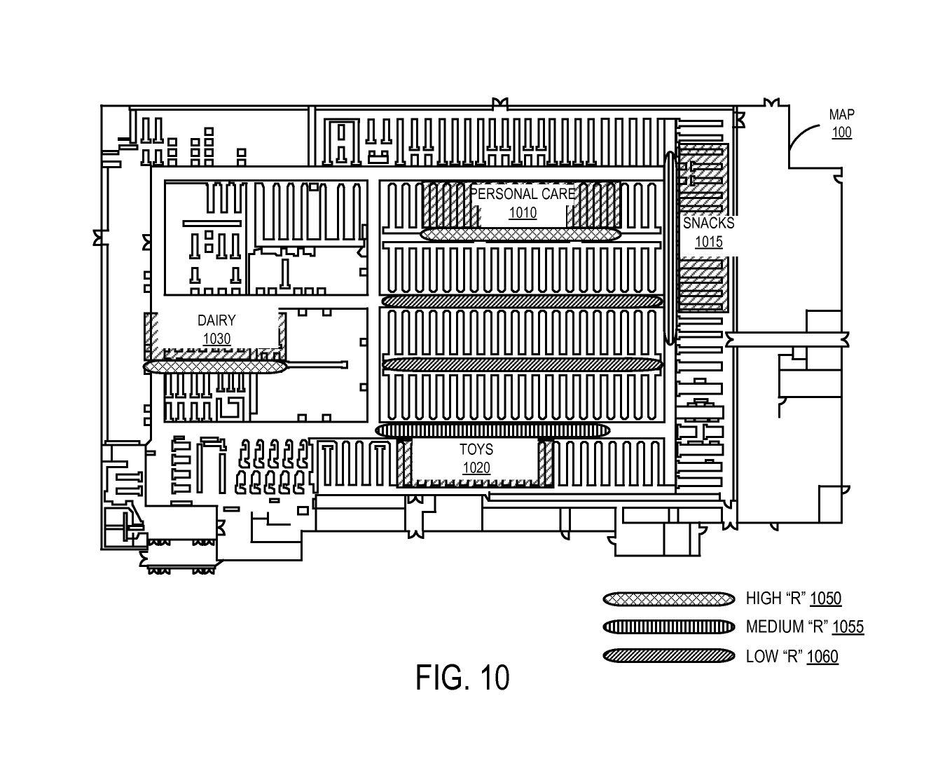

FIG. 10 illustrates exemplary product category locations within a mapped location. FIG. 10 illustrates example categories for Personal Care 1010, Dairy 1030, Toys 1020, and Snacks 1015. These example categories may be derived from mobile device trajectories and purchase transaction data as described above with respect to FIGS. 4 and 5. Each category type within the CMA map may contain metadata associated with the category. For example, Personal Care 1010 may have metadata indicating 20 visitors and 20 purchases for the category section in the CMA map. Snacks 1015 may have metadata indicating 30 visitors and 10 purchases for the category section in the CMA map. Toys 1020 may have metadata indicating 10 visitors and 3 purchases for the category section in the CMA map. Dairy 1030 may have metadata indicating 5 visitors and 5 purchases for the category section in the CMA map. Category types may have a running tally of visitors such that any mobile device within a threshold range of the category type location on the CMA map will trigger a counter to increase or aggregate a total number of visitors for the category type location. Additionally, CMA can trigger a purchase increment for each product purchased from a category type represented in a CMA map.

In some embodiments, the running totals or tally for purchases, visits, or other metadata may be reset or recalculated at predetermined times or at the request of a CMA administrator. For example, if the mapped location is reorganized such that product locations have changed, an administrator may trigger a reset of one or more categories affected by the reorganization. In other embodiments, CMA automatically detects changes in product positioning and may reset certain metadata (e.g., a total number of purchases or visits) in response to determining products are in a different or updated location.

In addition to the metadata for visitors and purchases associated with each product or category, CMA can calculate R and R′ ratios and associate the resulting values with the CMA map (e.g., stored as metadata). For example, with respect to FIG. 10, Dairy 1030 (R value=20/20=1) and Personal Care 1010 (R value=5/5=1) have relatively high R value of 1 and their R value may be assigned to their respective location 1050 within the map 100. Also with respect to FIG. 10, Toys 1020 (R value=3/10=0.3) and Snacks 1015 (R value=10/30=0.33) may be considered as having an average, medium, or mid-range R value 1055. Lastly, areas without any purchase transaction data may be considered to have relatively low R value 1060. In some embodiments, the gradations (e.g., low, medium, high) of R values may be stored as a field in metadata in addition to the raw R value. In other embodiments, the actual computed raw R value may be associated or stored with the category type. Furthermore, R values may be associated with specific products in some embodiments.

Those of skill would appreciate that the various illustrative logical blocks, modules, engines, circuits, and algorithm steps described in connection with the embodiments disclosed herein may be implemented as electronic hardware, computer software, or combinations of both. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In one embodiment, the previous CMA description may be implemented by one or more general purpose processors (e.g., device processor 201 and/or server processor 310) and in memory (e.g., device memory 205 or server memory 340) to achieve the previously desired functions (e.g., the methods of FIGS. 4 and 5).

In one or more exemplary embodiments, the functions or modules described may be implemented in hardware (e.g., device hardware 200, or server hardware 300), software, firmware, or any combination thereof. If implemented in software as a computer program product, the functions or modules may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for augmenting metadata for a mapped location, the method comprising:
receiving mapped location trajectory data for each of a plurality of mobile devices;
receiving, for each of the respective mobile devices, purchase transaction data for the respective mobile device at the mapped location;
correlating the purchase transaction data with the mapped location trajectory data to determine a purchased product location within the mapped location; and
augmenting the metadata for the mapped location to comprise the purchased product location.

2. The method of claim 1, providing the metadata for the mapped location to a requesting device.

3. The method of claim 1, wherein the mapped location trajectory data comprises a plurality of location coordinates visited by the mobile device along a shopping route through the mapped location.

4. The method of claim 3, wherein the mapped location trajectory data comprises time spent by the mobile device at each of the plurality of location coordinates.

5. The method of claim 1, wherein in response to the determining the purchased product location, associating the purchased product location with a category and augmenting the metadata to include the category.

6. The method of claim 1, further comprising:
aggregating a total number of visitors to each determined product location;
determining, for each purchased product location, one or more of: a sales to total visitor ratio, and profit to total visitor ratio; and
augmenting the metadata to comprise the determined ratios.

7. The method of claim 1, wherein the purchase transaction data is received from one or more of: a point of sale of the mapped location, or a respective mobile device application.

8. A machine readable non-transitory storage medium containing executable program instructions which cause a data processing device to perform a method for augmenting metadata for a mapped location, the method comprising:
receiving mapped location trajectory data for each of a plurality of mobile devices;
receiving, for each of the respective mobile devices, purchase transaction data for the respective mobile device at the mapped location;
correlating the purchase transaction data with the mapped location trajectory data to determine a purchased product location within the mapped location; and
augmenting the metadata for the mapped location to comprise the purchased product location.

9. The medium of claim 8, providing the metadata for the mapped location to a requesting device.

10. The medium of claim 8, wherein the mapped location trajectory data comprises a plurality of location coordinates visited by the mobile device along a shopping route through the mapped location.

11. The medium of claim 10, wherein the mapped location trajectory data comprises time spent by the mobile device at each of the plurality of location coordinates.

12. The medium of claim 8, wherein in response to the determining the purchased product location, associating the purchased product location with a category and augmenting the metadata to include the category.

13. The medium of claim 8, further comprising:
aggregating a total number of visitors to each determined product location;
determining, for each purchased product location, one or more of: a sales to total visitor ratio, and profit to total visitor ratio; and
augmenting the metadata to comprise the determined ratios.

14. The medium of claim 8, wherein the purchase transaction data is received from one or more of: a point of sale of the mapped location, or a respective mobile device application.

15. A data processing device comprising:
a processor; and
a storage device coupled to the processor and configurable for storing instructions, which, when executed by the processor cause the processor to:
receive mapped location trajectory data for each of a plurality of mobile devices;
receive, for each of the respective mobile devices, purchase transaction data for the respective mobile device at the mapped location;
correlate the purchase transaction data with the mapped location trajectory data to determine a purchased product location within the mapped location; and
augment the metadata for the mapped location to comprise the purchased product location.

16. The device of claim 15, providing the metadata in response to a request for the mapped location.

17. The device of claim 15, wherein the mapped location trajectory data comprises a plurality of location coordinates visited by the mobile device along a shopping route through the mapped location.

18. The device of claim 17, wherein the mapped location trajectory data comprises time spent by the mobile device at each of the plurality of location coordinates.

19. The device of claim 15, wherein in response to the determining the purchased product location, associating the purchased product location with a category and augmenting the metadata to include the category.

20. The device of claim 15, further comprising instructions to:
aggregate a total number of visitors to each determined product location;
determine, for each purchased product location, one or more of: a sales to total visitor ratio, and profit to total visitor ratio; and
augment the metadata to comprise the determined ratios.
